(19) United States
(12) Patent Application Publication
(10) Pub. No.: US 2017/0032749 A1
(43) Pub. Date: Feb. 2, 2017

(54) LIQUID CRYSTAL DISPLAY DEVICE

(71) Applicant: Shenzhen China Star Optoelectronics Technology Co. Ltd., Shenzhen, Guangdong (CN)

(72) Inventors: Siyang LIU, Shenzhen, Guangdong (CN); Tien-hao CHANG, Shenzhen, Guangdong (CN)

(73) Assignee: Shenzhen China Star Optoelectronics Technology Co. Ltd., Shenzhen, Guangdong (CN)

(21) Appl. No.: 14/771,146

(22) PCT Filed: Jul. 31, 2015
(86) PCT No.: PCT/CN2015/085707

§ 371 Date: Aug. 27, 2015

(30) Foreign Application Priority Data
Jul. 28, 2015 (CN) 201510450469.X

(51) Int. Cl. G09G 3/36; G09G 3/20

(52) U.S. Cl. CPC G09G 3/3614; G09G 3/2003; G09G 3/3677; G09G 3/3688; G09G 2300/0452; G09G 2320/0247

(57) ABSTRACT

A liquid crystal display device includes multiple sub-pixels arranged along a row direction and a column direction as a matrix and multiple data lines disposed along the column direction. Each data line is used for applying a data signal to a corresponding column of the sub-pixels. Each row of the sub-pixels includes even-number sub-pixels having different colors arranged periodically. When a pure color picture frame is displayed, and in even-number arrangement cycles formed by adjacently disposing sub-pixels having different colors along the row direction, for the sub-pixels having a same color, the number of the sub-pixels being applied with a positive polarity and the number of the sub-pixels being applied with a negative polarity are the same. The present invention can avoid generating a common electrode coupling signal because of a transient change of the data signals, and eliminate the flick phenomenon to improve the display quality.

### BACKGROUND OF THE INVENTION

1. Field of the Invention

The present invention relates to a display technology, and more particular to a liquid crystal display device.

2. Description of Related Art

A liquid crystal display device has features of low power consumption, low radiation, low manufacturing cost so that the liquid crystal display device has be widely applied in a variety of electronic equipment such as the TV, the cellular phone, the camera and the wearable device. Wherein, the four colors (RGBW) display technology of a Thin-Film-Transistor Liquid-Crystal-Display (TFT-LCD) has high light transmittance and high brightness such that the TFT-LCD is popular in the market.

Currently, when a liquid crystal display device drives liquid crystal molecules to be tilted in order to display a grayscale of a picture, an inversion driving method having both positive and negative polarities is usually adopted. The common polarity inversion method for a sub-pixel array is a dot inversion or a line inversion. However, the polarities of the data signals of adjacent data lines are opposite such that the polarities applied on adjacent columns of the sub-pixels are also opposite. When perform a four-color (RGBW) display, because of the data transient of the data signals such that the common electrode coupling (Vcom Coupling) is serious. At the same time, because polarities of sub-pixels having a same color may be the same, a serious flick phenomenon may be generated so as to affect the quality of a display picture of the liquid crystal display device.

In summary, the current technology that the data signal polarities outputted by the adjacent data lines are opposite cannot meet the requirement for the quality of the display picture of the RGBW liquid crystal display device.

### SUMMARY OF THE INVENTION

The main technology solved by the present invention is to provide a liquid crystal display device, when a pure color is displayed, for the sub-pixels having a same color, the number of the sub-pixels being applied with a positive polarity is the same as the number of the sub-pixels being applied with a negative polarity. The present invention can avoid generating a common electrode coupling signal because of a transient change of the data signals. At the same time, the flick phenomenon is also eliminated in order to improve the picture quality of the liquid crystal display device.

In order to solve above technology problems, a technology solution adopted by the present invention is to provide a liquid crystal display device, comprising: multiple sub-pixels arranged along a row direction and a column direction as a matrix; and multiple data lines disposed along the column direction, and each data line is used for applying a data signal to a corresponding column of the sub-pixels; wherein, in two adjacent rows of the sub-pixels disposed along the column direction, the sub-pixels having a same color is disposed in a same column; wherein, each row of the sub-pixels includes four sub-pixels having different colors arranged periodically; and wherein, when a liquid crystal display device displays a pure color picture frame, and in two arrangement cycles formed by adjacently disposing four sub-pixels having different colors along the row direction, a polarity of a data signal at a m-th column of the sub-pixels and a polarity of a data signal at a (m+4)-th column of the sub-pixels are opposite such that for the sub-pixels having a same color, the number of the sub-pixels being applied with a positive polarity is the same as the number of the sub-pixels being applied with a negative polarity, wherein, m is a positive integer that is greater than or equal to 1, and less than or equal to 4.

Wherein, the liquid crystal display device further includes a data driver; the data driver includes multiple output terminals corresponding to the multiple data lines in number; a polarity of a data signal of each output terminal is opposite with respect to a polarity of a data signal of an adjacent output terminal. wherein, in the two arrangement cycles formed by adjacently disposing four sub-pixels having different colors along the row direction, data lines corresponding to a portion of the sub-pixels are connected with the output terminals by a direct connection manner, and data lines corresponding to the other portion of the sub-pixels are connected with the output terminal by a crossover connection manner.

Wherein, the direct connection manner is to connect a n-th data line of the multiple data lines with a n-th output terminal of the data driver; a crossover connection manner is to connect a i-th data line of the multiple data lines with a (i+j)-th output terminal or a (i−j)-th output terminal, wherein, n and i are different positive integers, and j is an odd number.

Wherein, the four sub-pixels having different colors include a red (R) sub-pixel, a green (G) sub-pixel, a blue (B) sub-pixel and a white (W) sub-pixel.

In order to solve above technology problems, another technology solution adopted by the present invention is to provide a liquid crystal display device, comprising: multiple sub-pixels arranged along a row direction and a column direction as a matrix; and multiple data lines disposed along the column direction, and each data line is used for applying a data signal to a corresponding column of the sub-pixels; wherein, in two columns of the sub-pixels disposed adjacently along the column direction, the sub-pixels having a same color is disposed in a same column; wherein, each row of the sub-pixels includes even-number sub-pixels having different colors arranged periodically; and wherein, when a liquid crystal display device displays a pure color picture frame, and in even-number arrangement cycles formed by adjacently disposing sub-pixels having different colors along the row direction, for the sub-pixels having a same color, the number of the sub-pixels being applied with a positive polarity is the same as the number of the sub-pixels being applied with a negative polarity.

Wherein, the liquid crystal display device further includes a data driver; the data driver includes multiple output terminals corresponding to the multiple data lines in number; a polarity of a data signal of each output terminal is opposite with respect to a polarity of a data signal of an adjacent output terminal. wherein, in the even-number arrangement cycles formed by adjacently disposing sub-pixels having different colors along the row direction, data lines corresponding to a portion of the sub-pixels are connected with the output terminals by a direct connection manner, and data lines corresponding to the other portion of the sub-pixels are connected with the output terminals by a crossover connection manner.

Wherein, the direct connection manner is to connect a n-th data line of the multiple data lines with a n-th output terminal of the data driver; a crossover connection manner is to connect a i-th data line of the multiple data lines with a (i+j)-th output terminal or a (i−j)-th output terminal, wherein, n and i are different positive integers, and j is an odd number.

Wherein, the even-number sub-pixels having different colors are four sub-pixels having different colors; the even-number arrangement cycles are two arrangement cycles, wherein, in the two arrangement cycles, a polarity of a data signal at a m-th column of the sub-pixels and a polarity of a data signal at a (m+4)-th column of the sub-pixels are opposite, wherein, m is a positive integer that is greater than or equal to 1, and less than or equal to 4.

Wherein, in two adjacent rows of the sub-pixels disposed along the column direction, the sub-pixels having a same color is disposed in a same column.

Wherein, in two adjacent rows of the sub-pixels arranged along the column direction, the sub-pixels having a same color are staggered each other by one column or three columns.

Wherein, in two adjacent rows of the sub-pixels arranged along the column direction, the sub-pixels having a same color are staggered each other by two columns.

Wherein, the even-number sub-pixels having different colors include a red (R) sub-pixel, a green (G) sub-pixel, a blue (B) sub-pixel and a white (W) sub-pixel.

In order to solve above technology problems, another technology solution adopted by the present invention is to provide a liquid crystal display device, comprising: multiple sub-pixels arranged along a row direction and a column direction as a matrix; multiple data lines disposed along the column direction, and each data line is used for applying a data signal to a corresponding column of the sub-pixels; and a data driver, wherein, the data driver includes multiple output terminals corresponding to the multiple data lines in number, a polarity of a data signal of each output terminal is opposite with respect to a polarity of a data signal of an adjacent output terminal; wherein, data lines corresponding to a portion of the sub-pixels are connected with the output terminals by a direct connection manner, and data lines corresponding to the other portion of the sub-pixels are connected with the output terminals by a crossover connection manner.

Wherein, the direct connection manner is to connect a n-th data line of the multiple data lines with a n-th output terminal of the data driver; a crossover connection manner is to connect a i-th data line of the multiple data lines with a (i+j)-th output terminal or a (i−j)-th output terminal, wherein, n and i are different positive integers, and j is an odd number.

Wherein each row of the sub-pixels includes four sub-pixels having different colors arranged periodically, and wherein when a liquid crystal display device displays a pure color picture frame, and in two arrangement cycles formed by adjacently disposing four sub-pixels having different colors along the row direction, a polarity of a data signal at a m-th column of the sub-pixels and a polarity of a data signal at a (m+4)-th column of the sub-pixels are opposite such that for the sub-pixels having a same color, the number of the sub-pixels being applied with a positive polarity is the same as the number of the sub-pixels being applied with a negative polarity, wherein, m is a positive integer that is greater than or equal to 1, and less than or equal to 4.

Wherein, in two adjacent rows of the sub-pixels disposed along the column direction, the sub-pixels having a same color is disposed in a same column.

Wherein, in two adjacent rows of the sub-pixels arranged along the column direction, the sub-pixels having a same color are staggered each other by one column or three columns.

Wherein, in two adjacent rows of the sub-pixels arranged along the column direction, the sub-pixels having a same color are staggered each other by two columns.

Wherein, the four sub-pixels having different colors include a red (R) sub-pixel, a green (G) sub-pixel, a blue (B) sub-pixel and a white (W) sub-pixel.

The beneficial effect of the present invention is: the present invention provides a liquid crystal display device, comprising: multiple sub-pixels arranged along a row direction and a column direction as a matrix, and multiple data lines disposed along the column direction, and each data line is used for applying a data signal to a corresponding column of the sub-pixels. Wherein, each row of the sub-pixels includes even-number sub-pixels having different colors arranged periodically. When a liquid crystal display device displays a pure color picture frame, and in even-number arrangement cycles formed by adjacently disposing sub-pixels having different colors along the row direction, for the sub-pixels having a same color, the number of the sub-pixels being applied with a positive polarity is the same as the number of the sub-pixels being applied with a negative polarity. Comparing to the conventional art that polarities of the data signals outputted by adjacent columns of the data lines are opposite, when a pure color is displayed, for the sub-pixels having a same color, the number of the sub-pixels being applied with a positive polarity is the same as the number of the sub-pixels being applied with a negative polarity. Accordingly, the present invention can avoid generating a common electrode coupling signal because of a transient change of the data signals. At the same time, the flick phenomenon is also eliminated in order to improve the picture quality of the liquid crystal display device.

### BRIEF DESCRIPTION OF THE DRAWINGS

FIG. 1 is a schematic structure diagram of a liquid crystal display device according to an embodiment of the present invention;

FIG. 2 is a schematic timing diagram of data signals when a pure red picture frame is displayed in FIG. 1;

FIG. 3a is a schematic structure diagram of a connection manner between data lines and corresponding columns of the sub-pixels shown in FIG. 1;

FIG. 3b is a schematic timing diagram of data signals when a pure red picture frame is displayed in FIG. 3a;

FIG. 4a is a schematic structure diagram of a connection manner between data lines and corresponding columns of the sub-pixels shown in FIG. 1;

FIG. 4b is a schematic timing diagram of data signals when a pure red picture frame is displayed in FIG. 4a;

FIG. 5 is a schematic structure diagram of a liquid crystal display device according to embodiment of the present invention;

FIG. 6 is a schematic timing diagram of data signals when a pure red picture frame is displayed in FIG. 5;

FIG. 7a is a schematic structure diagram of a connection manner between data lines and corresponding column sub-pixels shown in FIG. 5;

FIG. 7b is a timing diagram of data signals when a pure red picture frame is displayed in FIG. 7a;

FIG. 8a is another schematic structure diagram of a connection manner between data lines and corresponding column sub-pixels shown in FIG. 5;

FIG. 8b is a timing diagram of data signals when a pure red picture frame is displayed in FIG. 8a;

FIG. 9 is a schematic structure diagram of a liquid crystal display device according to another embodiment of the present invention;

FIG. 10 is a timing diagram of data signals when a pure red picture frame is displayed in FIG. 9;

FIG. 11a is a schematic structure diagram of a connection manner between data lines and corresponding column sub-pixels shown in FIG. 9;

FIG. 11b is a timing diagram of data signals when a pure red picture frame is displayed in FIG. 11a;

FIG. 12a is another schematic structure diagram of a connection manner between data lines and corresponding column sub-pixels shown in FIG. 9; and

FIG. 12b is a timing diagram of data signals when a pure red picture frame is displayed in FIG. 12a.

### DETAILED DESCRIPTION OF THE PREFERRED EMBODIMENT

The following content combines figures and embodiments for detail description of the present invention.

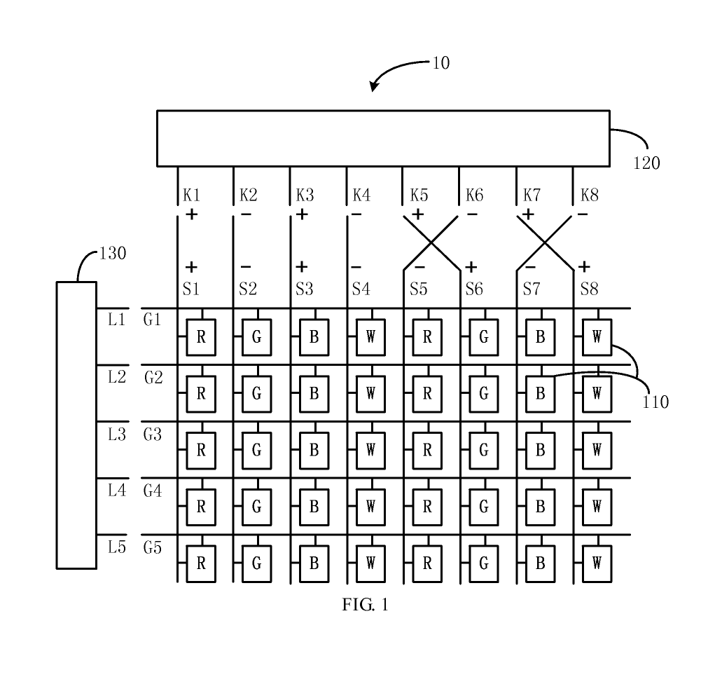

With reference to FIG. 1, and FIG. 1 is a schematic structure diagram of a liquid crystal display device according to an embodiment of the present invention. As shown in FIG. 1, the liquid crystal display device 10 includes multiple sub-pixels 110 arranged along a row direction and a column direction as a matrix, and multiple data lines disposed along the column direction. The multiple data lines are used for respectively applying data signals to corresponding columns of the sub-pixels. The liquid crystal display device 10 further includes multiple scanning lines (or gate lines) disposed along the row direction. The multiple scanning lines are used for respectively applying scanning signals to corresponding rows of the sub-pixels 110 in order to turn on each row of the sub-pixels 110 so as to receive a data signal connected at each column of the sub-pixels. In FIG. 1, a liquid crystal display device 10 includes sub-pixels 110 having five rows and eight columns. Gn represents a scanning line connected with an n-th row of the sub-pixels 110, and Sn represents an n-th data line, wherein, n is a positive integer. Each row of the sub-pixels 110 includes even-number sub-pixels 110 having different colors and arranged periodically. When the liquid crystal display device 10 displays a pure color picture frame, in even-number arrangement cycle formed by adjacently disposing sub-pixels 110 having different along the row direction, for the sub-pixels 110 having a same color, the number of the sub-pixels 110 being applied with a positive polarity is the same as the number of the sub-pixels 110 being applied with a negative polarity.

Wherein, as shown in FIG. 1, the even number sub-pixels 110 having different colors are four colors of the sub-pixels 110, which includes a red sub-pixel (represented by R sub-pixel in the following content and drawings), a green sub-pixel (represented by G sub-pixel in the following content and drawings), a blue sub-pixel (represented by B sub-pixel in the following content and drawings), and a white sub-pixel (represented by W sub-pixel in the following content and drawings).

Wherein, as shown in FIG. 1, in two adjacent rows of the sub-pixels 110 disposed along a column direction, the sub-pixels 110 having a same color is disposed in a same column, that is, the sub-pixels 110 in each column have a same color. Furthermore, each data line is connected with a corresponding column of the sub-pixels 110.

Wherein, when a liquid crystal display device 10 displays a pure color picture frame, and in even-number arrangement cycles formed by adjacently disposing the sub-pixels 110 having different colors along a row direction, the number of the sub-pixels 110 having a same color being applied with a positive polarity is the same as the number of the sub-pixels 110 having the same color being applied with a negative polarity. Specifically, as shown in FIG. 1, an R sub-pixel, a G sub-pixel, a B sub-pixel and a W sub-pixel are arranged in one arrangement cycle so as to form two arrangement cycles (the even-number arrangement cycles). In the two arrangement cycles, a polarity of a data signal at an m-th column of the sub-pixels and a polarity of a data signal at a (m+4)-th column of the sub-pixels are opposite. Wherein, m is a positive integer that is greater than or equal to 1, and less than or equal to 4. Accordingly, the number of the sub-pixels 110 having a same color being applied with a positive polarity is the same as the number of the sub-pixels 110 having the same color being applied with a negative polarity. Specifically, a polarity of a data signal applied at an m-th column of a data line Sm and a polarity of a data signal applied at a (m+4)-th column of Sm+4 are opposite.

Specifically, polarities of data signals on a first data line S1, a second data line S2, a third data line S3, a fourth data line S4, a fifth data line S5, a sixth data line S6, a seventh data line S7 and an eighth data line S8 are a positive polarity (+), a negative polarity (−), a positive polarity (+), a negative polarity (−), a negative polarity (−), positive polarity (+), a negative polarity (−) and a positive polarity (+), respectively. In two arrangement cycles using a R sub-pixel, a G sub-pixel, a B sub-pixel and a W sub-pixel as one arrangement cycle along a row direction, a polarity of a data signal of a first data line S1 and a polarity of a data signal of a fifth data line S5 are opposite such that a polarity of a data signal of a first column of R sub-pixels and a polarity of a data signal of a fifth column of R sub-pixels are opposite so as to meet a condition that in the R sub-pixels having a same color, the number of a first column of the R sub-pixels being applied with a positive polarity is the same as the number of a fifth column of the R sub-pixels being applied with a negative polarity.

Similarly, a polarity of a data signal of a second data line S2 and a polarity of a data signal of a sixth data line S6 are opposite such that a polarity of a data signal of a second column of G sub-pixels and a polarity of a data signal of a sixth column of G sub-pixels are opposite so as to meet a condition that for the G sub-pixels having a same color, the number of a sixth column of the G sub-pixels being applied with a positive polarity is the same as the number of a second column of the G sub-pixels being applied with a negative polarity. A polarity of a data signal of a third data line S3 and a polarity of a data signal of a seventh data line S7 are opposite such that a polarity of a data signal of a third column of B sub-pixels and a polarity of a data signal of a seventh column of B sub-pixels are opposite so as to meet a condition that for the B sub-pixels having a same color, the number of a third column of the B sub-pixels being applied with a positive polarity is the same as the number of a seventh column of the B sub-pixels being applied with a negative polarity. A polarity of a data signal of a fourth data line S4 and a polarity of a data signal of a eighth data line S8 are opposite such that a polarity of a data signal of a fourth column of W sub-pixels and a polarity of a data signal of a eighth column of W sub-pixels are opposite so as to meet a condition that for the W sub-pixels having a same color, the number of an eighth column of the W sub-pixels being applied with a positive polarity is the same as the number of a fourth column of the W sub-pixels being applied with a negative polarity.

Wherein, in the sub-pixels having a same color, the number of the sub-pixels 110 being applied with a positive polarity and the number of the sub-pixels 110 being applied with a negative polarity are the same. That is, when displaying a pure color picture, a half of polarities of the sub-pixels 110 having a same color are positive, and the other half of polarities of the sub-pixels 110 having a same color is negative. Accordingly, when driving the sub-pixels 110 to perform a grayscale display in a column inversion or a dot inversion, common electrode coupling because of transient change of data signals can be avoided, and the flick phenomenon can be eliminated at the same time in order to improve the picture quality of the liquid crystal display device. Wherein, in FIG. 1 and the following content, a column inversion driving method is used as an example.

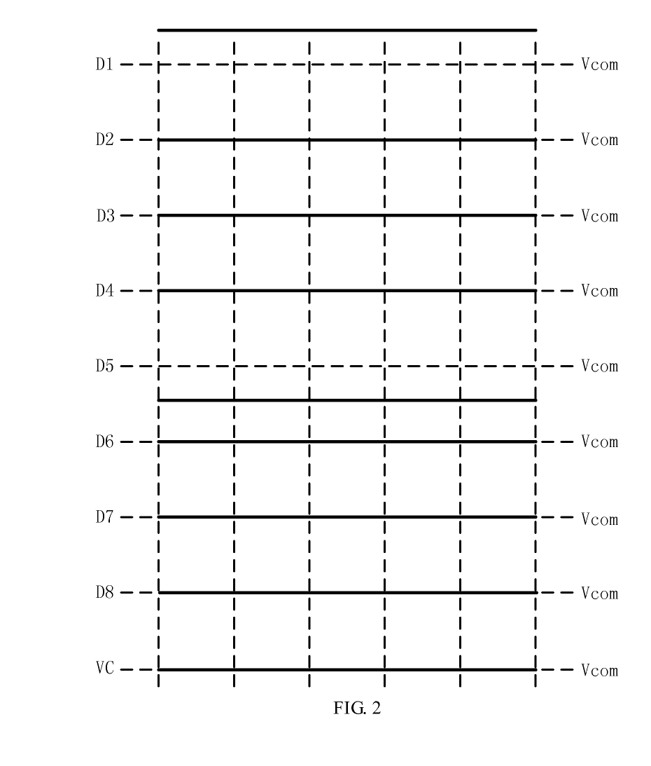

With reference to FIG. 2, and FIG. 2 is a schematic timing diagram of data signals when a pure red picture frame is displayed in FIG. 1. When a liquid crystal display device 10 displays a pure color picture frame, a timing diagram of each data line applying a data signal to a corresponding column of the sub-pixels 110 is represented as applying a data signal Dn on an n-th data line Sn. A positive polarity means that a data signal Dn is greater than a common electrode voltage Vcom of the sub-pixels 110, and a negative polarity means that a data signal Dn is less than a common electrode voltage Vcom of the sub-pixels 110.

Wherein, in FIG. 1, each data line corresponds to a column of the sub-pixels 110. With combined reference to FIG. 2, when the liquid crystal display device 10 displays a pure red picture frame, a polarity of a data signal D1 on a first data line S1 and a polarity of a data signal D5 on a fifth data line S5 are opposite such that the polarity of the data signal D1 applied on a first column of the R sub-pixels and a polarity of a data signal D5 applied on a fifth column of the R sub-pixels are opposite. The other data lines correspondingly display the other colors. Therefore, data signals applied on the other data lines are the same as the common electrode Vcom. At this time, for the R sub-pixels, one half of polarities of the data signals are positive, and the other half of polarities of the data signals are negative in order to avoid generating a common electrode coupling signal because of a transient change of the data signals. In FIG. 2, VC represents the common electrode coupling signal. At the same time, the flick phenomenon is also eliminated in order to improve the picture quality of the liquid crystal display device. Similarly, when displaying the other pure colors such as a green (G) color, a blue (B) color, a white (W) color or anyone color composed of the above colors. For the R sub-pixels, G sub-pixels, the B sub-pixels, or the W sub-pixels, one half of the polarities of the data signals are positive and the other half of the polarities of the data signals are negative in order to avoid generating a common electrode coupling signal because of a transient change of the data signals. At the same time, the flick phenomenon is also eliminated in order to improve the picture quality of the liquid crystal display device.

With reference to FIG. 1, the liquid crystal display device 10 further includes a data driver 120 and a scanning driver 130. The scanning driver 130 includes multiple charging terminals corresponding to multiple scanning lines in number, and multiple output terminals corresponding to multiple data lines in number. In FIG. 1, five charging terminals are illustrated as an example, and Ln represents an n-th charging terminal. A scanning line corresponding to each row of the sub-pixels 110 is directly connected with the charging terminal. In FIG. 1, eight output terminals are illustrated as an example, and Kn represents an n-th output terminal. A polarity of a data signal of each output terminal is opposite with respect to a polarity of a data signal of adjacent output terminal. Wherein, in even-number arrangement cycles formed by adjacently disposing sub-pixels 110 having different colors along a row direction, data lines corresponding to a portion of the sub-pixels 110 are connected with the output terminals by a direct connection manner, and data lines corresponding to the other portion of the sub-pixels 110 are connected with output terminals by a crossover connection manner.

Wherein, the direct connection manner is to connect an n-th scanning line Gn of the multiple scanning lines with an n-th charging terminal Ln of the scanning driver 130 or to connect an n-th data line Sn of the multiple data lines with an n-th output terminal Kn of the data driver 120. A crossover connection manner is to connect an i-th data line S1 of the multiple data lines with a (i+j)-th output terminal Ki+j or a (i−j)-th output terminal Ki−j, wherein, n and i are different positive integers, and j is an odd number.

Specifically, in the two arrangement cycles shown in FIG. 1, a first column of the data line S1, a second column of the data line S2, a third column of the data line S3 and the fourth column of the data line S4 are respectively connected with the output terminals K1, K2, K3 and K4 by a direct connection manner. In addition, a fifth column of the data line S5, a sixth column of the data line S6, a seventh column of the data line S7 and an eighth column of the data line S8 are respectively connected with the output terminals K6, K5, K8 and K7 by a crossover connection manner, at this time, j is equal to 1 or −1. In another embodiment, the connection manner between the data lines and the output terminals are not limited as FIG. 1. A fifth column of the data line S5, a sixth column of the data line S6, a seventh column of the data line S7 and an eighth column of the data line S8 can be respectively connected with corresponding output terminals by a direct connection manner. A first column of the data line S1, a second column of the data line S2, a third column of the data line S3 and the fourth column of the data line S4 can be respectively connected with corresponding output terminals by a crossover connection manner. Similarly, the j is not limited to be equal to 1 or −1, and the j can be other odd numbers. The present invention can set connection manners and a specific value of the j according to specific arrangement cycles.

In addition, in another embodiment, the data driver 120 utilizes even-number output terminals as arrangement cycles. Polarities of data signals of output terminals of each arrangement cycle are symmetric with respect to polarities of data signals of output terminals of an adjacent arrangement cycle. As shown in FIG. 1, a data driver 120 can utilize four output terminals as an arrangement cycle. Polarities of output terminals K1, K2, K3 and K4 in a first arrangement cycle are symmetric with respect to polarities of output terminals K5, K6, K7 and K8 in a second arrangement cycle. For example, the output terminals K1, K2, K3 and K4 respectively output a positive polarity data signal, a negative polarity data signal, a positive polarity data signal, and a negative polarity data signal. The output terminals K5, K6, K7 and K8 respectively output a negative polarity data signal, a positive polarity data signal, a negative polarity data signal, a positive polarity data signal. Accordingly, the polarities of the data signals are symmetric. At this time, data lines corresponding to all of the sub-pixels 110 are connected with the output terminals by a direct connection manner such that in the eve-number arrangement cycles formed by adjacently disposing the sub-pixels having different colors along a row direction, for the sub-pixels 110 having a same color, the number of the sub-pixels 110 being applied with a positive polarity and the number of the sub-pixels 110 being applied with a negative polarity are the same.

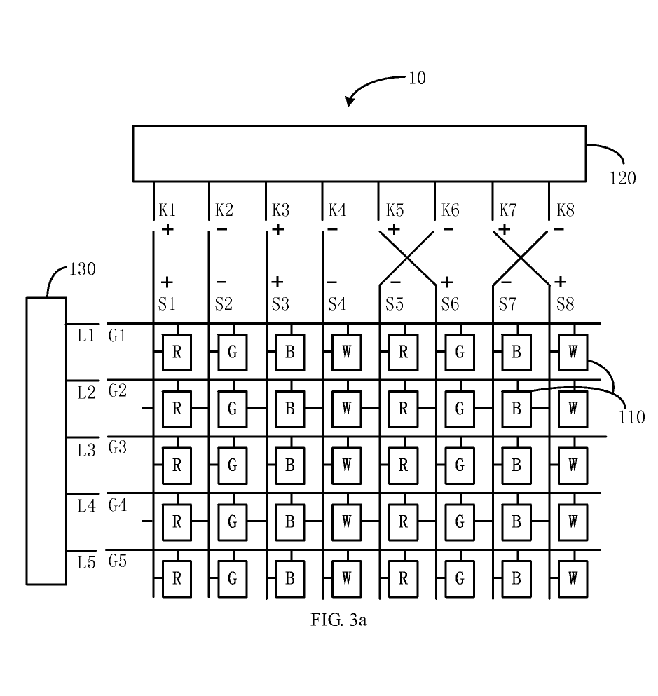

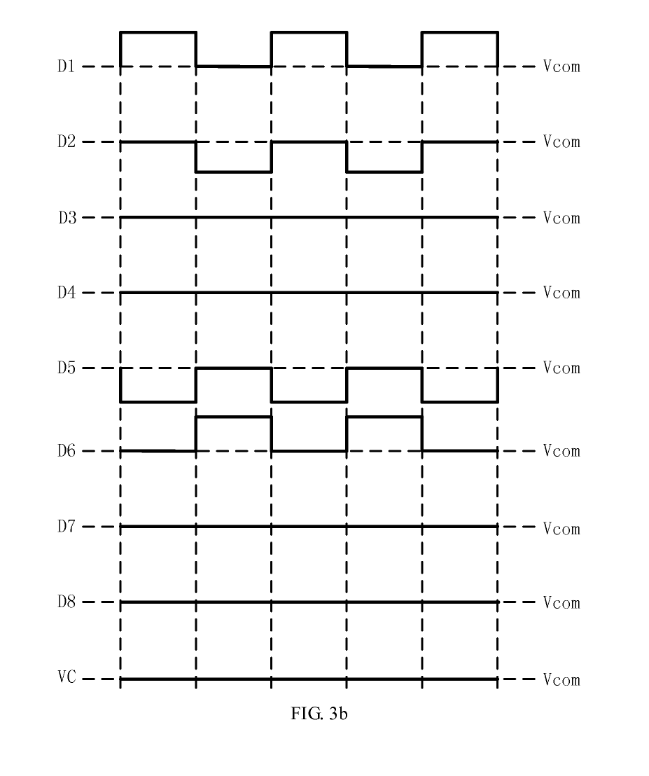

With reference to FIG. 3a, FIG. 3a is a schematic structure diagram of a connection manner between data lines and corresponding columns of the sub-pixels shown in FIG. 1. As shown in FIG. 3a, each data line is connected with two adjacent columns of the sub-pixels 110 by a first turnover manner. Wherein, the first turnover manner is that each data line is alternately connected with different rows of the sub-pixels located at two sides of the each data line. In addition, each data line is connected with odd rows of the sub-pixels 110 at a side far away from the scanning driver 130, and each data line is connected with even rows of the sub-pixels at a side close to the scanning driver 130.

Specifically, as shown in FIG. 3a, in two arrangement cycles formed by adjacently disposing a R sub-pixel, a G sub-pixel, a B sub-pixel and a W sub-pixel as one arrangement cycle along a row direction, a first data line S1 is respectively connected with sub-pixels 110 located at a first column and first row, a first column and third row, a previous column (previous than the first column) and second row, and a previous column and fourth row. A second data line S2 is respectively connected with sub-pixels 110 located at a second column and first row, a second column and third row, a first column and second row, and a first column and fourth row. Similarly, each of a third data line S3, a fourth data line S4, a fifth data line S5, a sixth data line S6, a seventh data line S7 and an eighth data line S8 is respectively connected with two adjacent columns of the sub-pixels 110 by the first turnover manner of the first and second data lines S1, S2.

With reference to FIG. 3b, FIG. 3b is a schematic timing diagram of data signals when a pure red picture frame is displayed in FIG. 3a. When the liquid crystal display device 10 displays a pure red color picture frame, a polarity of a data signal D1 on a first column of a data line S1 is opposite with respect to a polarity of a data signal D5 on a fifth column of a data line S5; a polarity of a data signal D2 on a second column of a data line S2 is opposite with respect to a polarity of a data signal D6 on a sixth column of a data line S6. The other data lines correspondingly display the other colors. Therefore, data signals applied on the other data lines are the same as the common electrode voltage Vcom. At this time, for the R sub-pixels, one half of the polarities of the data signals are positive and the other half of the polarities of the data signals are negative in order to avoid generating a common electrode coupling signal because of a transient change of the data signals. At the same time, the flick phenomenon is also eliminated in order to improve the picture quality of the liquid crystal display device.

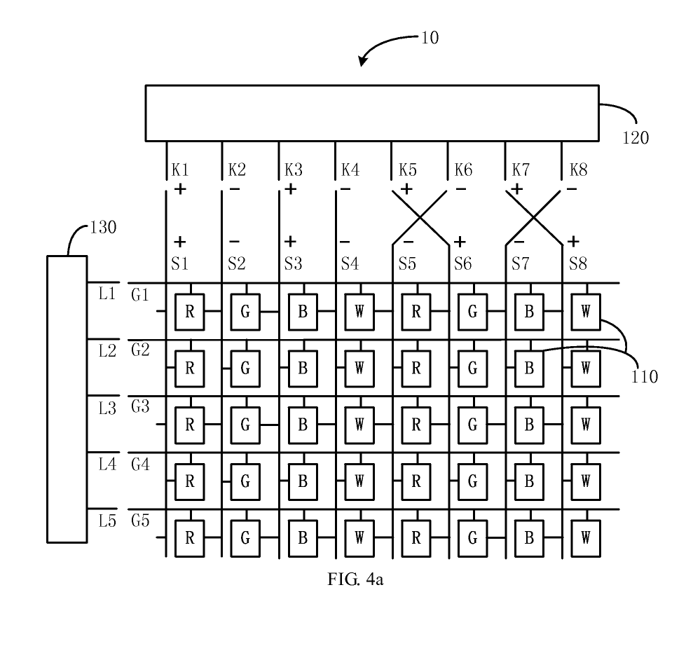

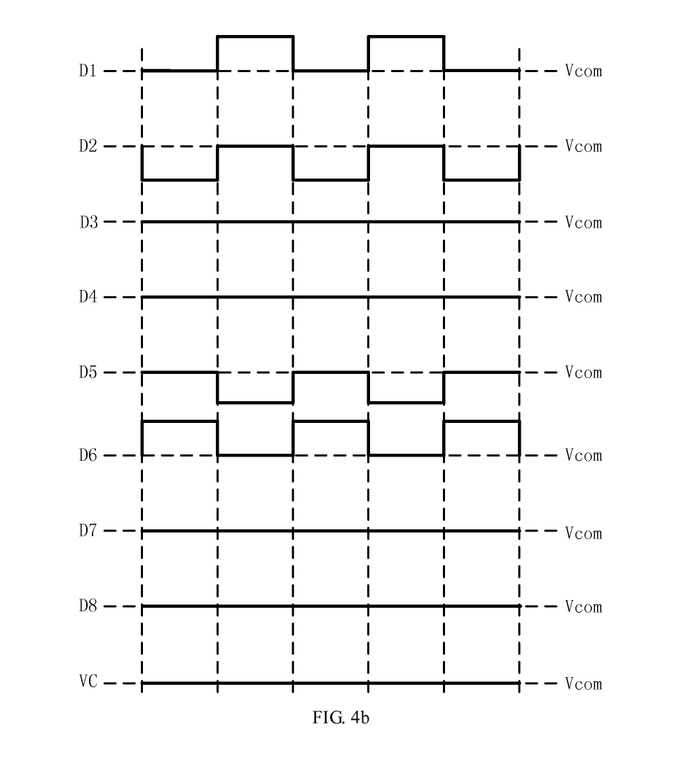

With reference to FIG. 4a, FIG. 4a is a schematic structure diagram of a connection manner between data lines and corresponding columns of the sub-pixels shown in FIG. 1. As shown in FIG. 4a, each data line is connected with two adjacent columns of the sub-pixels 110 by a second turnover manner. Wherein, the second turnover manner is that each data line is alternately connected with different rows of the sub-pixels located at two sides of the each data line. In addition, each data line is connected with odd rows of the sub-pixels 110 at a side close to the scanning driver 130, and each data line is connected with even rows of the sub-pixels at a side far away from the scanning driver 130. Specifically, as shown in FIG. 4a, in two arrangement cycles formed by adjacently disposing a R sub-pixel, a G sub-pixel, a B sub-pixel and a W sub-pixel as one arrangement cycle along a row direction, a first data line S1 is respectively connected with sub-pixels 110 located at a first column and second row, a first column and fourth row, a previous column (previous than the first column) and first row, and a previous column and third row. A second data line S2 is respectively connected with sub-pixels 110 located at a second column and second row, a second column and fourth row, a first column and first row, and a first column and third row. Similarly, each of a third data line S3, a fourth data line S4, a fifth data line S5, a sixth data line S6, a seventh data line S7 and a eighth data line S8 is respectively connected with two adjacent columns of the sub-pixels 110 by the second turnover manner of the first and second data lines S1, S2.

With reference to FIG. 4b, FIG. 4b is a schematic timing diagram of data signals when a pure red picture frame is displayed in FIG. 4a. When the liquid crystal display device 10 displays a pure red color picture frame, a polarity of a data signal D1 on a first column of a data line S1 is opposite with respect to a polarity of a data signal D5 on a fifth column of a data line S5; a polarity of a data signal D2 on a second column of a data line S2 is opposite with respect to a polarity of a data signal D6 on a sixth column of a data line S6. The other data lines correspondingly display the other colors. Therefore, data signals applied on the other data lines are the same as the common electrode voltage Vcom. At this time, for the R sub-pixels, one half of the polarities of the data signals are positive and the other half of the polarities of the data signals are negative in order to avoid generating a common electrode coupling signal because of a transient change of the data signals. At the same time, the flick phenomenon is also eliminated in order to improve the picture quality of the liquid crystal display device.

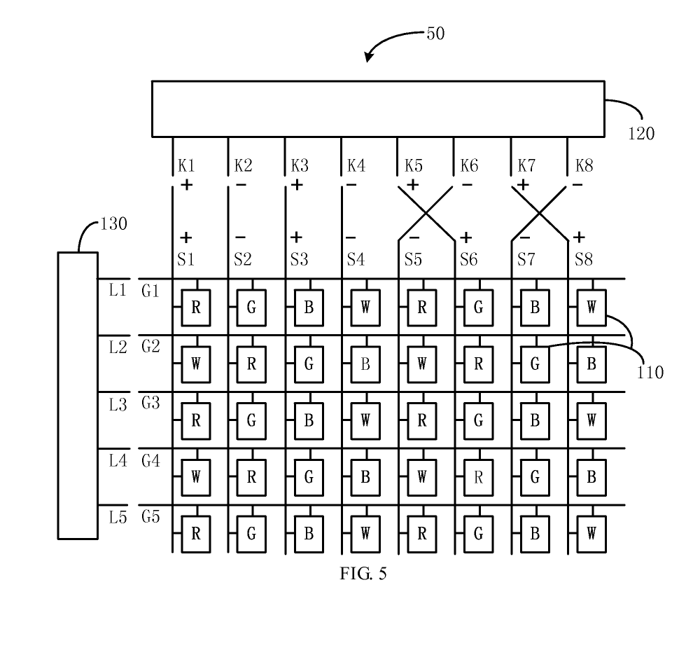

With reference to FIG. 5, and FIG. 5 is a schematic structure diagram of a liquid crystal display device according to an embodiment of the present invention. As shown in FIG. 5, a liquid crystal display device 50 includes basically the same elements and denoted by the same numerals as the liquid crystal display device 10 shown in FIG. 1. In two adjacent rows of the sub-pixels 110 arranged along a column direction, the sub-pixels 110 having a same color are staggered each other by one column or three columns. Specifically, as shown in FIG. 5, in two arrangement cycles formed by adjacently disposing a R sub-pixel, a G sub-pixel, a B sub-pixel and a W sub-pixel as one arrangement cycle along a row direction, each of odd rows such as a first row and a third row of the sub-pixels 110 utilizes a R sub-pixel, a G sub-pixel, a B sub-pixel and a W sub-pixel as one arrangement cycle. Each of even rows such as a second row and a fourth row of the sub-pixels utilizes a W sub-pixel, an R sub-pixel, a G sub-pixel and a B sub-pixel as one arrangement cycle, wherein, each data line is connected with one corresponding column of the sub-pixels 110. In another embodiment, an odd-number row can respectively select a W sub-pixel, an R sub-pixel, a G sub-pixel and a B sub-pixel as one arrangement cycle, and an even-number row can select an R sub-pixel, a G sub-pixel, a B sub-pixel and a W sub-pixel as one arrangement cycle.

Wherein, as shown in FIG. 5, polarities of data signals on a first data line S1, a second data line S2, a third data line S3, a fourth data line S4, a fifth data line S5, a sixth data line S6, a seventh data line S7 and an eighth data line S8 are a positive polarity (+), a negative polarity (−), a positive polarity (+), a negative polarity (−), a negative polarity (−), positive polarity (+), a negative polarity (−) and a positive polarity (+), respectively. When the liquid crystal display device 50 displays a pure color picture frame, in two arrangement cycles formed by adjacently disposing the sub-pixels 110 having different color along a row direction, for the sub-pixels having a same color, the number of the sub-pixels 110 being applied with a positive polarity and the number of the sub-pixels 110 being applied with a negative polarity are the same.

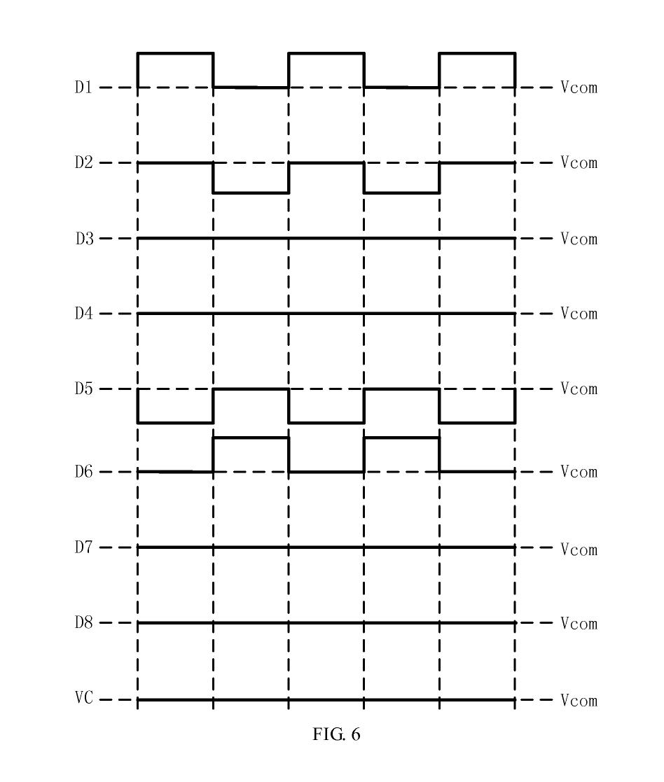

With reference to FIG. 6, FIG. 6 is a schematic timing diagram of data signals when a pure red picture frame is displayed in FIG. 5. When the liquid crystal display device 50 displays a pure red color picture frame, a polarity of a data signal D1 on a first column of a data line S1 is opposite with respect to a polarity of a data signal D5 on a fifth column of a data line S5; a polarity of a data signal D2 on a second column of a data line S2 is opposite with respect to a polarity of a data signal D6 on a sixth column of a data line S6. The other data lines correspondingly display the other colors. Therefore, data signals applied on the other data lines are the same as the common electrode Vcom. At this time, for the R sub-pixels, one half of the polarities of the data signals are positive and the other half of the polarities of the data signals are negative in order to avoid generating a common electrode coupling signal because of a transient change of the data signals. At the same time, the flick phenomenon is also eliminated in order to improve the picture quality of the liquid crystal display device.

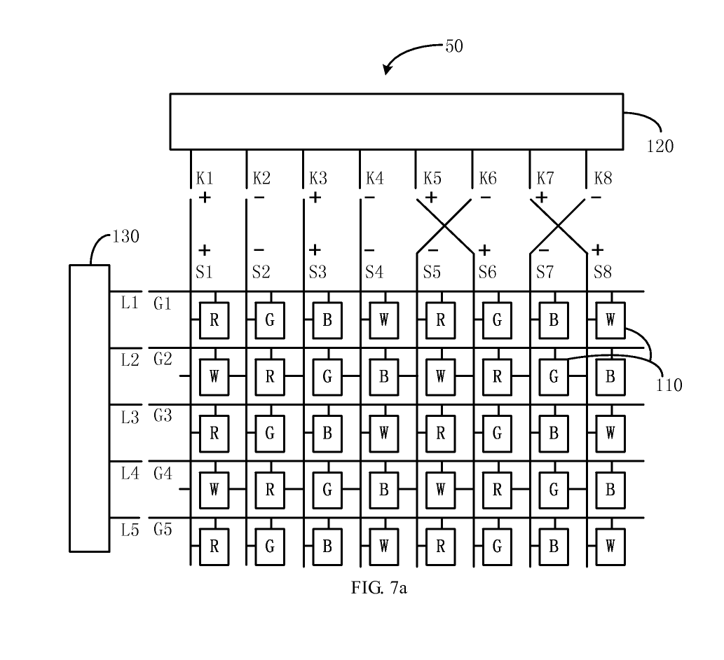

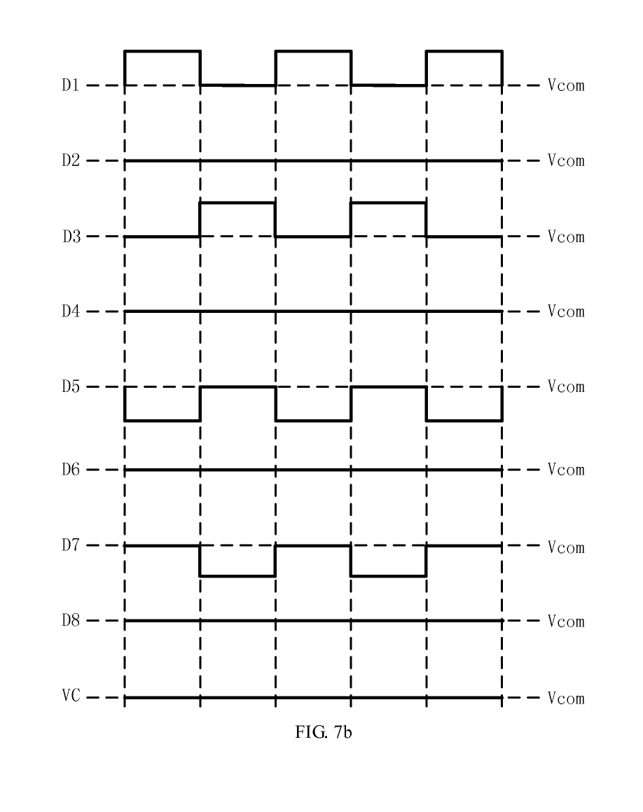

With reference to FIG. 7a and FIG. 7b, wherein, FIG. 7a is a schematic structure diagram of a connection manner between data lines and corresponding columns of the sub-pixels shown in FIG. 5. FIG. 7b is a schematic timing diagram of data signals when a pure red picture frame is displayed in FIG. 7a. As shown in FIG. 7a, each data line is connected with two adjacent columns of the sub-pixels 110 by a first turnover manner. Wherein, the first turnover manner can refer to above related description and the connection manner between each data line and two adjacent columns of the sub-pixels 110 shown in FIG. 3a. With combined reference to FIG. 7a and FIG. 7b, when the liquid crystal display device 50 displays a pure red color picture frame, in two arrangement cycles formed by adjacently disposing a R sub-pixel, a G sub-pixel, a B sub-pixel and a W sub-pixel as one arrangement cycle along a row direction, a polarity of a data signal D1 on a first column of a data line S1 is opposite with respect to a polarity of a data signal D5 on a fifth column of a data line S5; a polarity of a data signal D3 on a third column of a data line S3 is opposite with respect to a polarity of a data signal D7 on a seventh column of a data line S7. The other data lines correspondingly display the other colors. Therefore, data signals applied on the other data lines are the same as the common electrode Vcom. At this time, for the R sub-pixels, one half of the polarities of the data signals are positive and the other half of the polarities of the data signals are negative in order to avoid generating a common electrode coupling signal because of a transient change of the data signals. At the same time, the flick phenomenon is also eliminated in order to improve the picture quality of the liquid crystal display device.

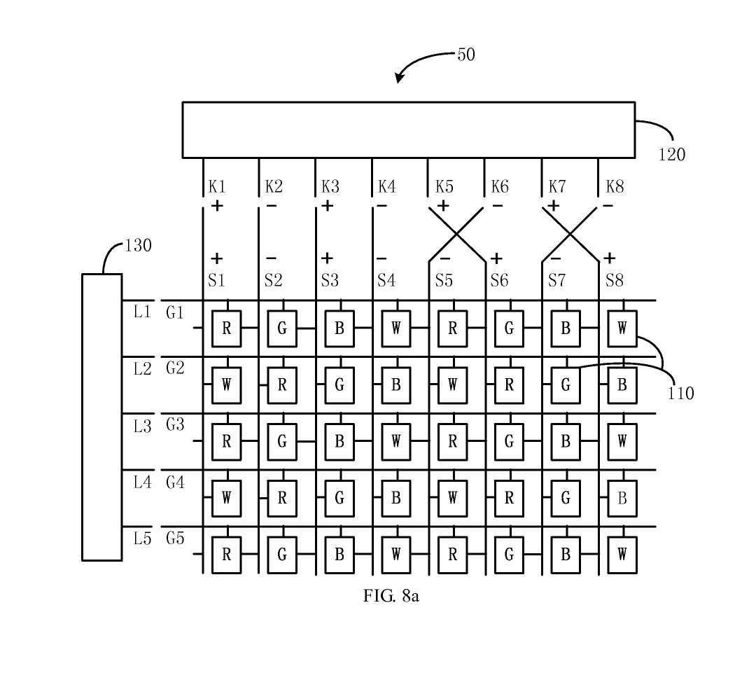

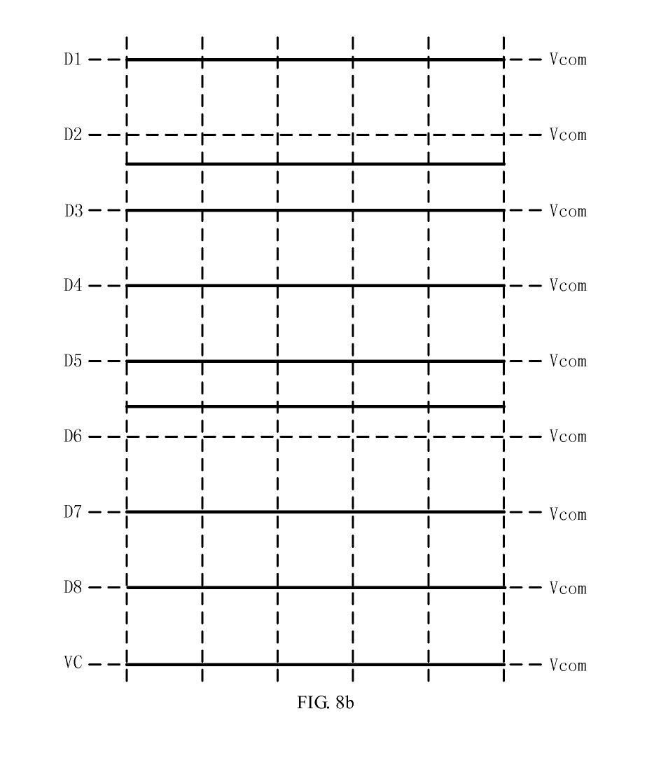

With reference to FIG. 8a and FIG. 8b, wherein, FIG. 8a is a schematic structure diagram of a connection manner between data lines and corresponding columns of the sub-pixels shown in FIG. 5, and FIG. 8b is a schematic timing diagram of data signals when a pure red picture frame is displayed in FIG. 8a. As shown in FIG. 8a, each data line is connected with two adjacent columns of the sub-pixels 110 by a second turnover manner. Wherein, the second turnover manner can refer to above related description and the connection manner between each data line and two adjacent columns of the sub-pixels 110 shown in FIG. 4a.

With combined reference to FIG. 8a and FIG. 8b, when the liquid crystal display device 50 displays a pure red color picture frame, in two arrangement cycles formed by adjacently disposing a R sub-pixel, a G sub-pixel, a B sub-pixel and a W sub-pixel as one arrangement cycle along a row direction, a polarity of a data signal D2 on a second column of a data line S2 is opposite with respect to a polarity of a data signal D6 on a sixth column of a data line S6. The other data lines correspondingly display the other colors. Therefore, data signals applied on the other data lines are the same as the common electrode voltage Vcom. At this time, for the R sub-pixels, one half of the polarities of the data signals are positive and the other half of the polarities of the data signals are negative in order to avoid generating a common electrode coupling signal because of a transient change of the data signals. At the same time, the flick phenomenon is also eliminated in order to improve the picture quality of the liquid crystal display device.

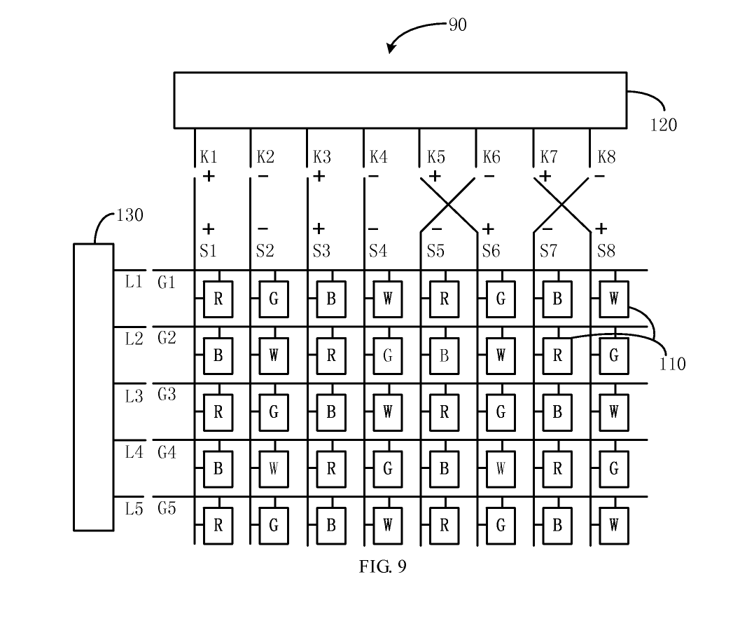

With reference to FIG. 9, and FIG. 9 is a schematic structure diagram of a liquid crystal display device according to embodiment of the present invention. As shown in FIG. 9, a liquid crystal display device 90 includes basically the same elements and denoted by the same numerals as the liquid crystal display device 10 shown in FIG. 1. In two adjacent rows of the sub-pixels 110 arranged along a column direction, the sub-pixels 110 having a same color are staggered each other by two columns. Specifically, as shown in FIG. 9, in two arrangement cycles formed by adjacently disposing a R sub-pixel, a G sub-pixel, a B sub-pixel and a W sub-pixel as one arrangement cycle along a row direction, each of odd rows such as a first row and a third row of the sub-pixels 110 utilizes a R sub-pixel, a G sub-pixel, a B sub-pixel and a W sub-pixel as one arrangement cycle. Each of even rows such as a second row and a fourth row of the sub-pixels utilizes a B sub-pixel, a W sub-pixel, an R sub-pixel and a G sub-pixel as one arrangement cycle, wherein, each data line is connected with one corresponding column of the sub-pixels 110.

Wherein, as shown in FIG. 9, polarities of data signals on a first data line S1, a second data line S2, a third data line S3, a fourth data line S4, a fifth data line S5, a sixth data line S6, a seventh data line S7 and an eighth data line S8 are sequentially a positive polarity (+), a negative polarity (−), a positive polarity (+), a negative polarity (−), a negative polarity (−), positive polarity (+), a negative polarity (−) and a positive polarity (+), respectively. When the liquid crystal display device 90 displays a pure color picture frame, in two arrangement cycles formed by adjacently disposing sub-pixels 110 having different colors along a row direction, for the sub-pixels having a same color, the number of the sub-pixels 110 being applied with a positive polarity and the number of the sub-pixels 110 being applied with a negative polarity are the same.

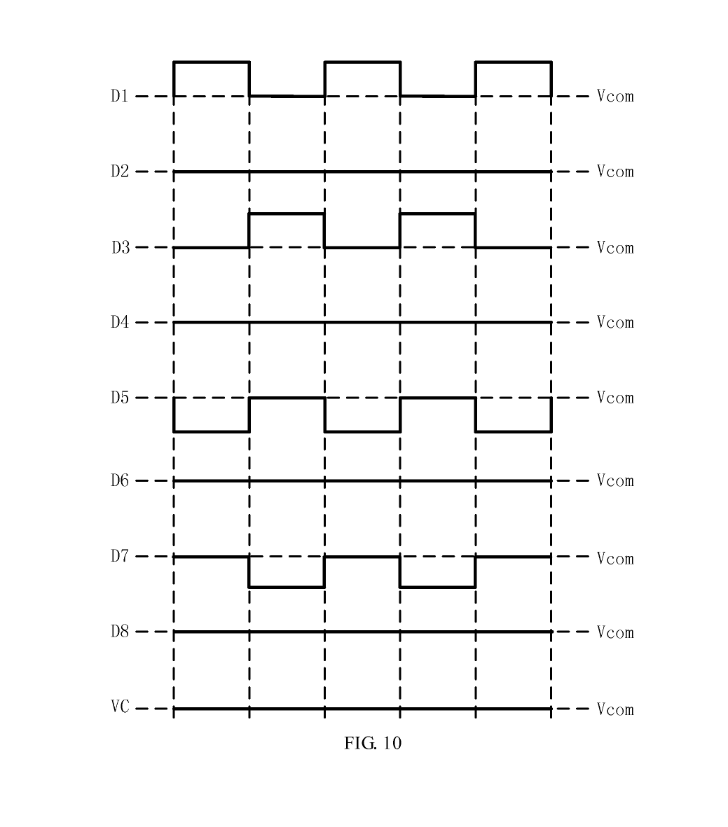

With reference to FIG. 10, FIG. 10 is a schematic timing diagram of data signals when a pure red picture frame is displayed in FIG. 9. When the liquid crystal display device 90 displays a pure red color picture frame, a polarity of a data signal D1 on a first column of a data line S1 is opposite with respect to a polarity of a data signal D5 on a fifth column of a data line S5; a polarity of a data signal D3 on a third column of a data line S3 is opposite with respect to a polarity of a data signal D7 on a seventh column of a data line S7. The other data lines correspondingly display the other colors. Therefore, data signals applied on the other data lines are the same as the common electrode voltage Vcom. At this time, for the R sub-pixels, one half of the polarities of the data signals are positive and the other half of the polarities of the data signals are negative in order to avoid generating a common electrode coupling signal because of a transient change of the data signals. At the same time, the flick phenomenon is also eliminated in order to improve the picture quality of the liquid crystal display device.

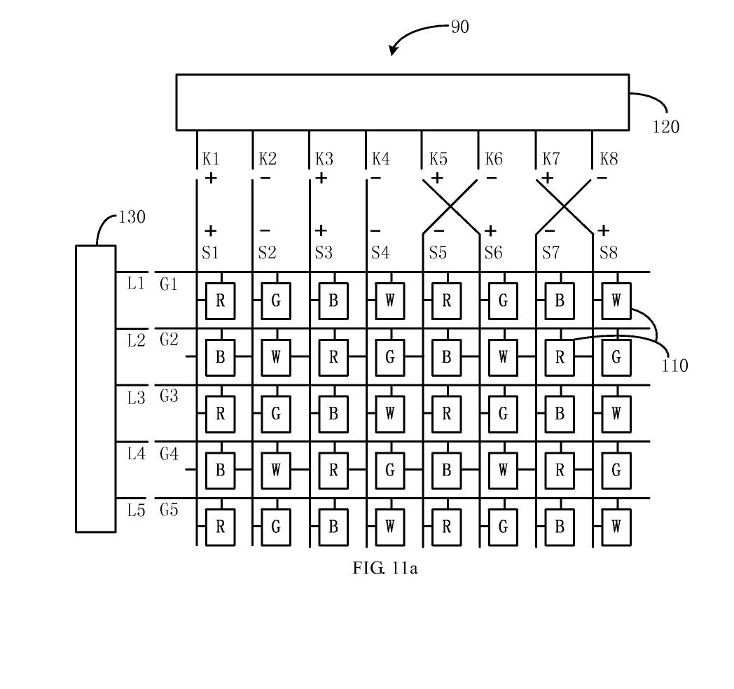

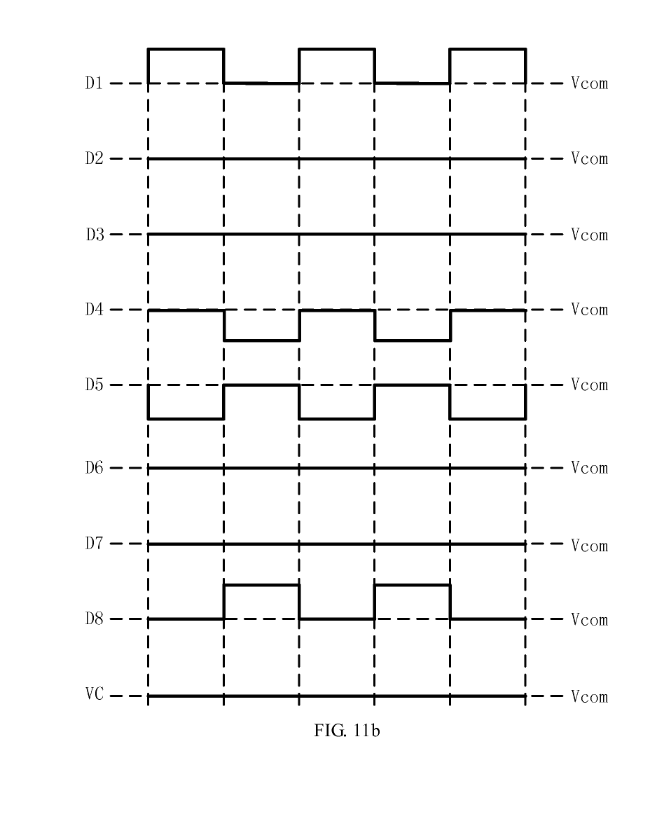

With reference to FIG. 11a and FIG. 11b, wherein, FIG. 11a is a schematic structure diagram of a connection manner between data lines and corresponding columns of the sub-pixels shown in FIG. 9. FIG. 11b is a schematic timing diagram of data signals when a pure red picture frame is displayed in FIG. 11a. As shown in FIG. 11a, each data line is connected with two adjacent columns of the sub-pixels 110 by a first turnover manner. Wherein, the first turnover manner can refer to above related description and the connection manner between each data line and two adjacent columns of the sub-pixels 110 shown in FIG. 4a. With combined reference to FIG. 11a and FIG. 11b, when the liquid crystal display device 90 displays a pure red color picture frame, in two arrangement cycles formed by adjacently disposing a R sub-pixel, a G sub-pixel, a B sub-pixel and a W sub-pixel as one arrangement cycle along a row direction, a polarity of a data signal D1 on a first column of a data line S1 is opposite with respect to a polarity of a data signal D5 on a fifth column of a data line S5; a polarity of a data signal D4 on a fourth column of a data line S4 is opposite with respect to a polarity of a data signal D8 on an eighth column of a data line S8. The other data lines correspondingly display the other colors. Therefore, data signals applied on the other data lines are the same as the common electrode voltage Vcom. At this time, for the R sub-pixels, one half of the polarities of the data signals are positive and the other half of the polarities of the data signals are negative in order to avoid generating a common electrode coupling signal because of a transient change of the data signals. At the same time, the flick phenomenon is also eliminated in order to improve the picture quality of the liquid crystal display device.

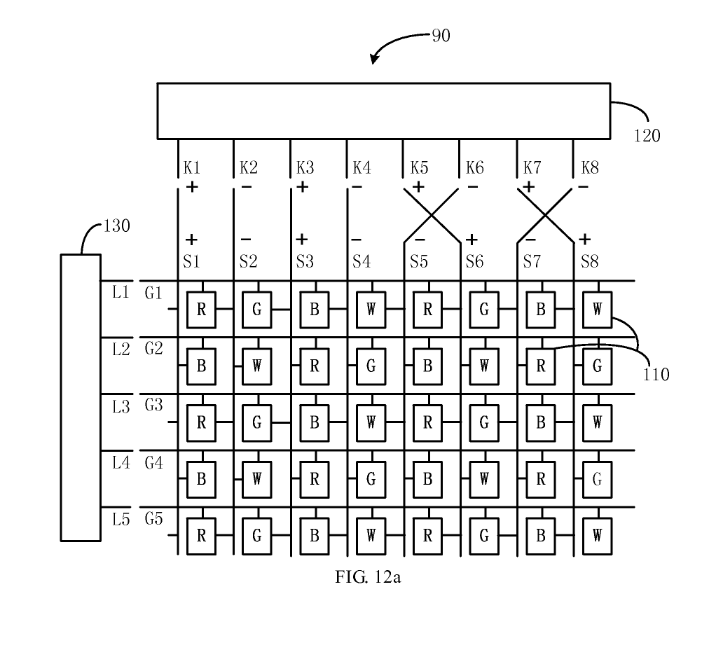

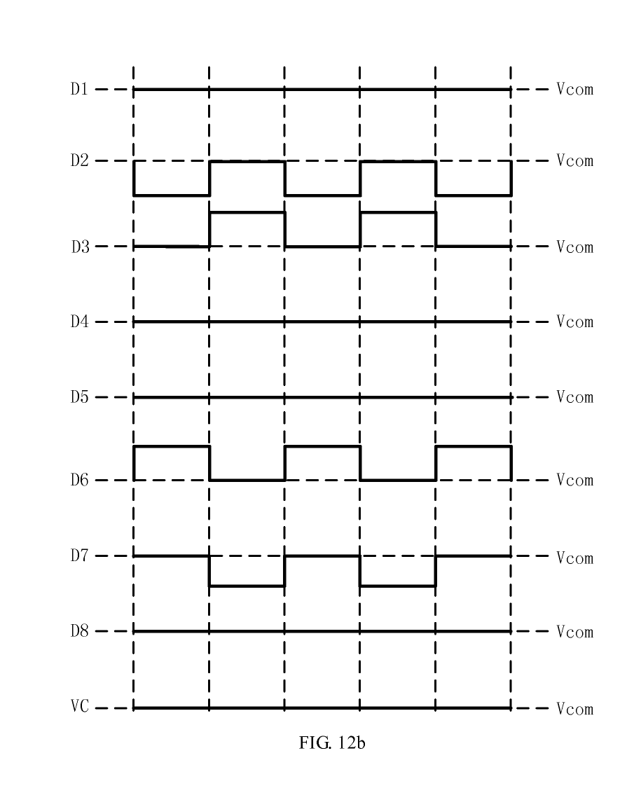

With reference to FIG. 12a and FIG. 12b, wherein, FIG. 12a is a schematic structure diagram of a connection manner between data lines and corresponding columns of the sub-pixels shown in FIG. 9. FIG. 12b is a schematic timing diagram of data signals when a pure red picture frame is displayed in FIG. 12a. As shown in FIG. 12a, each data line is connected with two adjacent columns of the sub-pixels 110 by a second turnover manner. Wherein, the second turnover manner can refer to above related description and the connection manner between each data line and two adjacent columns of the sub-pixels 110 shown in FIG. 4a.

With combined reference to FIG. 12a and FIG. 12b, when the liquid crystal display device 90 displays a pure red color picture frame, in two arrangement cycles formed by adjacently disposing a R sub-pixel, a G sub-pixel, a B sub-pixel and a W sub-pixel as one arrangement cycle along a row direction, a polarity of a data signal D2 on a second column of a data line S2 is opposite with respect to a polarity of a data signal D6 on a sixth column of a data line S6. A polarity of a data signal D3 on a third column of a data line S3 is opposite with respect to a polarity of a data signal D7 on a seventh column of a data line S7. The other data lines correspondingly display the other colors. Therefore, data signals applied on the other data lines are the same as the common electrode voltage Vcom. At this time, for the R sub-pixels, one half of the polarities of the data signals are positive and the other half of the polarities of the data signals are negative in order to avoid generating a common electrode coupling signal because of a transient change of the data signals. At the same time, the flick phenomenon is also eliminated in order to improve the picture quality of the liquid crystal display device.

Wherein, the present invention also provides a liquid crystal display device. As shown in FIG. 1, the liquid crystal display device 10 includes multiple sub-pixels 110 arranged along a row direction and a column direction as a matrix, and multiple data lines disposed along the column direction. The multiple data lines are used for respectively applying data signals to corresponding columns of the sub-pixels. Wherein, the liquid crystal display device 10 further includes a data driver 120 and a scanning driver 130. The scanning driver 130 includes multiple charging terminals corresponding to multiple scanning lines in number, and multiple output terminals corresponding to multiple data lines. A polarity of a data signal of each output terminal is opposite to a polarity of a data signal of adjacent output terminal. Wherein, a portion of the sub-pixels 110 are connected with output terminals through a direct connection manner, and data lines corresponding to the other portion of the sub-pixels 110 are connected with output terminals through a crossover connection manner.

Wherein, the direct connection manner is to connect an n-th data line of the multiple data lines with an n-th output terminal Kn of the data driver 120. A crossover connection manner is to connect an i-th data line of the multiple data lines with a (i+j)-th output terminal Ki+j or a (i−j)-th output terminal Ki−j, wherein, n and i are different positive integers, and j is an odd number. The liquid crystal display device of the present embodiment and the liquid crystal display device shown in FIG. 1 have basically the same elements and function.

Comparing to the conventional art, the present invention provides a liquid crystal display device, comprising: multiple sub-pixels arranged along a row direction and a column direction as a matrix, and multiple data lines disposed along the column direction, and each data line is used for applying a data signal to a corresponding column of the sub-pixels. Wherein, each row of the sub-pixels includes even-number sub-pixels having different colors arranged periodically. When a liquid crystal display device displays a pure color picture frame, and in even-number arrangement cycles formed by adjacently disposing sub-pixels having different colors along the row direction, for the sub-pixels having a same color, the number of the sub-pixels being applied with a positive polarity is the same as the number of the sub-pixels being applied with a negative polarity. Comparing to the conventional art that polarities of the data signals outputted by adjacent columns of the data lines are opposite, when a pure color is displayed, for the sub-pixels having a same color, the number of the sub-pixels being applied with a positive polarity is the same as the number of the sub-pixels being applied with a negative polarity. Accordingly, the present invention can avoid generating a common electrode coupling signal because of a transient change of the data signals. At the same time, the flick phenomenon is also eliminated in order to improve the picture quality of the liquid crystal display device.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

1. A liquid crystal display device, comprising:
multiple sub-pixels arranged along a row direction and a column direction as a matrix; and
multiple data lines disposed along the column direction, and each data line is used for applying a data signal to a corresponding column of the sub-pixels;
wherein, in two adjacent rows of the sub-pixels disposed along the column direction, the sub-pixels having a same color is disposed in a same column;
wherein, each row of the sub-pixels includes four sub-pixels having different colors arranged periodically; and
wherein, when a liquid crystal display device displays a pure color picture frame, and in two arrangement cycles formed by adjacently disposing four sub-pixels having different colors along the row direction, a polarity of a data signal at a m-th column of the sub-pixels and a polarity of a data signal at a (m+4)-th column of the sub-pixels are opposite such that for the sub-pixels having a same color, the number of the sub-pixels being applied with a positive polarity is the same as the number of the sub-pixels being applied with a negative polarity, wherein, m is a positive integer that is greater than or equal to 1, and less than or equal to 4.

2. The liquid crystal display device according to claim 1, wherein, the liquid crystal display device further includes a data driver; the data driver includes multiple output terminals corresponding to the multiple data lines in number; a polarity of a data signal of each output terminal is opposite with respect to a polarity of a data signal of an adjacent output terminal. wherein, in the two arrangement cycles formed by adjacently disposing four sub-pixels having different colors along the row direction, data lines corresponding to a portion of the sub-pixels are connected with the output terminals by a direct connection manner, and data lines corresponding to the other portion of the sub-pixels are connected with the output terminal by a crossover connection manner.

3. The liquid crystal display device according to claim 2, wherein, the direct connection manner is to connect a n-th data line of the multiple data lines with a n-th output terminal of the data driver; a crossover connection manner is to connect a i-th data line of the multiple data lines with a (i+j)-th output terminal or a (i−j)-th output terminal, wherein, n and i are different positive integers, and j is an odd number.

4. The liquid crystal display device according to claim 1, wherein, the four sub-pixels having different colors include a red (R) sub-pixel, a green (G) sub-pixel, a blue (B) sub-pixel and a white (W) sub-pixel.

5. A liquid crystal display device, comprising:
multiple sub-pixels arranged along a row direction and a column direction as a matrix; and
multiple data lines disposed along the column direction, and each data line is used for applying a data signal to a corresponding column of the sub-pixels;
wherein, in two columns of the sub-pixels disposed adjacently along the column direction, the sub-pixels having a same color is disposed in a same column;
wherein, each row of the sub-pixels includes even-number sub-pixels having different colors arranged periodically; and
wherein, when a liquid crystal display device displays a pure color picture frame, and in even-number arrangement cycles formed by adjacently disposing sub-pixels having different colors along the row direction, for the sub-pixels having a same color, the number of the sub-pixels being applied with a positive polarity is the same as the number of the sub-pixels being applied with a negative polarity.

6. The liquid crystal display device according to claim 5, wherein, the liquid crystal display device further includes a data driver; the data driver includes multiple output terminals corresponding to the multiple data lines in number; a polarity of a data signal of each output terminal is opposite with respect to a polarity of a data signal of an adjacent output terminal. wherein, in the even-number arrangement cycles formed by adjacently disposing sub-pixels having different colors along the row direction, data lines corresponding to a portion of the sub-pixels are connected with the output terminals by a direct connection manner, and data lines corresponding to the other portion of the sub-pixels are connected with the output terminals by a crossover connection manner.

7. The liquid crystal display device according to claim 6, wherein, the direct connection manner is to connect a n-th data line of the multiple data lines with a n-th output terminal of the data driver; a crossover connection manner is to connect a i-th data line of the multiple data lines with a (i+j)-th output terminal or a (i−j)-th output terminal, wherein, n and i are different positive integers, and j is an odd number.

8. The liquid crystal display device according to claim 5, wherein, the even-number sub-pixels having different colors are four sub-pixels having different colors; the even-number arrangement cycles are two arrangement cycles, wherein, in the two arrangement cycles, a polarity of a data signal at a m-th column of the sub-pixels and a polarity of a data signal at a (m+4)-th column of the sub-pixels are opposite, wherein, m is a positive integer that is greater than or equal to 1, and less than or equal to 4.

9. The liquid crystal display device according to claim 5, wherein, in two adjacent rows of the sub-pixels disposed along the column direction, the sub-pixels having a same color is disposed in a same column.

10. The liquid crystal display device according to claim 5, wherein, in two adjacent rows of the sub-pixels arranged along the column direction, the sub-pixels having a same color are staggered each other by one column or three columns.

11. The liquid crystal display device according to claim 5, wherein, in two adjacent rows of the sub-pixels arranged along the column direction, the sub-pixels having a same color are staggered each other by two columns.

12. The liquid crystal display device according to claim 5, wherein, the even-number sub-pixels having different colors include a red (R) sub-pixel, a green (G) sub-pixel, a blue (B) sub-pixel and a white (W) sub-pixel.

13. A liquid crystal display device, comprising:
multiple sub-pixels arranged along a row direction and a column direction as a matrix;
multiple data lines disposed along the column direction, and each data line is used for applying a data signal to a corresponding column of the sub-pixels; and
a data driver, wherein, the data driver includes multiple output terminals corresponding to the multiple data lines in number, a polarity of a data signal of each output terminal is opposite with respect to a polarity of a data signal of an adjacent output terminal;
wherein, data lines corresponding to a portion of the sub-pixels are connected with the output terminals by a direct connection manner, and data lines corresponding to the other portion of the sub-pixels are connected with the output terminals by a crossover connection manner.

14. The liquid crystal display device according to claim 13, wherein, the direct connection manner is to connect a n-th data line of the multiple data lines with a n-th output terminal of the data driver; a crossover connection manner is to connect a i-th data line of the multiple data lines with a (i+j)-th output terminal or a (i−j)-th output terminal, wherein, n and i are different positive integers, and j is an odd number.

15. The liquid crystal display device according to claim 13, wherein each row of the sub-pixels includes four sub-pixels having different colors arranged periodically, and wherein when a liquid crystal display device displays a pure color picture frame, and in two arrangement cycles formed by adjacently disposing four sub-pixels having different colors along the row direction, a polarity of a data signal at a m-th column of the sub-pixels and a polarity of a data signal at a (m+4)-th column of the sub-pixels are opposite such that for the sub-pixels having a same color, the number of the sub-pixels being applied with a positive polarity is the same as the number of the sub-pixels being applied with a negative polarity, wherein, m is a positive integer that is greater than or equal to 1, and less than or equal to 4.

16. The liquid crystal display device according to claim 13, wherein, in two adjacent rows of the sub-pixels disposed along the column direction, the sub-pixels having a same color is disposed in a same column.

17. The liquid crystal display device according to claim 13, wherein, in two adjacent rows of the sub-pixels arranged along the column direction, the sub-pixels having a same color are staggered each other by one column or three columns.

18. The liquid crystal display device according to claim 13, wherein, in two adjacent rows of the sub-pixels arranged along the column direction, the sub-pixels having a same color are staggered each other by two columns.

19. The liquid crystal display device according to claim 13, wherein, the four sub-pixels having different colors include a red (R) sub-pixel, a green (G) sub-pixel, a blue (B) sub-pixel and a white (W) sub-pixel.
